(19) United States
(12) Patent Application Publication
(10) Pub. No.: US 2021/0062835 A1
(43) Pub. Date: Mar. 4, 2021

(54) CLAMP WITH RECESS TO RECEIVE AND SECURE ARTICLES

(71) Applicant: Aero Northwest Design & Manufactuirng, Inc., Kent, WA (US)

(72) Inventor: Krystave Saeter, Kent, WA (US)

(21) Appl. No.: 16/858,461

(22) Filed: Apr. 24, 2020

Related U.S. Application Data
(60) Provisional application No. 62/892,278, filed on Aug. 27, 2019.

(51) Int. Cl. F16B 2/06

(52) U.S. Cl. CPC F16B 2/065; B60R 9/048

(57) ABSTRACT

A clamp assembly to be mounted to a structure, for example a tubular structure such as a vehicle roll bar, is disclosed. The clamp assembly includes a recess to receive and secure an article relative to the structure. The clamp assembly includes a first clamp portion and a second clamp portion. The first clamp portion is securable to the second clamp portion such that the structure is captured between the first inner clamping surface and the second inner clamping surface. The first clamp portion defines a recess, which extends through an outer surface of the first clamp portion and terminates at a base surface of the first clamp portion that is positioned between the outer surface and the first inner clamping surface.

### BACKGROUND

### Technical Field

This disclosure relates to systems and methods that secure articles to structures, and more particularly, to the use of a clamp assembly to secure an article to a tubular structure.

### Description of the Related Art

Cargo space inside many vehicles is limited. Known exterior storage options, such as the Vehicle Rooftop Carrier Apparatus disclosed in U.S. Pat. No. 6,152,339, are designed to support a specific type of article or storage system. Further, these known options may include multiple components that add considerable weight to the vehicle.

A lightweight, modular, storage system that is easy to attach and remove from a vehicle may result in increased utility of the vehicle to which such a system is attached.

### BRIEF SUMMARY

Embodiments described herein provide systems and methods of securing articles to structures.

According to one embodiment, a clamp assembly is capable of being mounted to a structure. The clamp assembly includes a first clamp portion and a second clamp portion. The first clamp portion includes a first inner clamping surface and an outer surface, the first clamp portion defines a recess, which extends through the outer surface in a first direction and terminates at a base surface of the first clamp portion. The base surface is positioned between the outer surface and the first inner clamping surface with respect to the first direction, and the recess defines a first width at the outer surface and a second width at a location between the outer surface and the base surface. Both the first width and the second width are measured in a second direction that is perpendicular to the first direction, and the second width is greater than the first width. The second clamp portion includes a second inner clamping surface, and the first clamp portion is securable to the second clamp portion such that the structure is captured between the first inner clamping surface and the second inner clamping surface.

According to one embodiment, a method of mounting a clamp assembly to a structure includes positioning a first clamp portion of the clamp assembly relative to a second clamp portion of the clamp assembly such that both a first inner clamping surface of the first clamp portion and a second inner clamping surface of the second clamp portion abut the structure, a first fastener receiving aperture defined by the first clamp portion is aligned with a second fastener receiving aperture defined by the second clamp portion along a first direction, and a recess defined by the first clamp portion extends through an outer surface of the first clamp portion in the first direction and terminates at a base surface of the first clamp portion, the base surface positioned between the outer surface and the first inner clamping surface with respect to the first direction, wherein the recess defines a first width at the outer surface and a second width at a location between the outer surface and the base surface, both the first width and the second width being measured in a second direction that is perpendicular to the first direction, and the second width being greater than the first width.

The method further includes inserting a fastener through one of the first fastener receiving aperture and the second fastener receiving aperture and into the other of the first fastener receiving aperture and the second fastener receiving aperture, thereby simultaneously fixing the relative positions of the first clamp portion and the second clamp portion and securing the clamp assembly relative to the structure.

According to one embodiment, a method of securing an article to a tubular structure includes positioning a first clamp portion of the clamp assembly relative to a second clamp portion of the clamp assembly such that both a first inner clamping surface of the first clamp portion and a second inner clamping surface of the second clamp portion abut the tubular structure. The method further includes simultaneously fixing the relative positions of the first clamp portion and the second clamp portion and securing the clamp assembly relative to the tubular structure.

The method further includes inserting a portion of the article through a first portion of a recess defined by the first clamp portion by advancing the article in a first direction. The recess extends through an outer surface of the first clamp portion in the first direction and terminates at a base surface of the first clamp portion, and the base surface is positioned between the outer surface and the first inner clamping surface with respect to the first direction. The method further includes aligning the portion of the article with a second portion of the recess that the portion of the article does not fit through with respect to the first direction, thereby trapping the portion of the article within the recess.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a side, elevation view of a clamp assembly attached to a vehicle, according to one embodiment.

FIG. 2 is an isometric view of the clamp assembly illustrated in FIG. 1 attached to a tubular structure and coupled to a fitting, according to one embodiment.

FIG. 3 is an isometric view of the fitting illustrated in FIG. 2, according to one embodiment.

FIG. 4 is an isometric view of the clamp assembly illustrated in FIG. 1 attached to a tubular structure, according to one embodiment.

FIG. 5 is an exploded isometric view of the clamp assembly illustrated in FIG. 4.

FIG. 6 is an isometric view of a first clamp portion of the clamp assembly illustrated in FIG. 4, according to one embodiment.

FIG. 7 is a front, elevation view of the first clamp portion illustrated in FIG. 6.

FIG. 8 is a side, cross-sectional view of a portion of the first clamp portion illustrated in FIG. 6 along line 8-8, according to one embodiment.

FIG. 9 is a rear, cross-sectional view of the portion of the first clamp portion illustrated in FIG. 6 along line 9-9, according to one embodiment.

FIG. 10 is a side, cross-sectional view of the portion illustrated in FIG. 6 along line 8-8, with an article at a first position within a recess of the portion according to one embodiment.

FIG. 11 is a rear, cross-sectional view of the portion illustrated in FIG. 9 with the article in the first position, according to one embodiment.

FIG. 12 is a side, cross-sectional view of the portion illustrated in FIG. 6 along line 8-8, with an article at a second position within the recess of the portion according to one embodiment.

FIG. 13 is a front, cross-sectional view of the portion illustrated in FIG. 6 along line 13-13, with the article in the second position, according to one embodiment.

FIG. 14 is also a front, cross-sectional view of the portion illustrated in FIG. 6 along line 13-13, with the article in the second position, according to one embodiment.

FIG. 15 is an isometric view of the first clamp portion of the clamp assembly illustrated in FIG. 1, according to one embodiment.

FIG. 16 is an isometric view of the a second clamp portion of the clamp assembly illustrated in FIG. 4, according to one embodiment.

FIG. 17 is an isometric view of a second clamp portion of the clamp assembly illustrated in FIG. 4, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with clamp assemblies have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For example, certain features of the disclosure which are described herein in the context of separate embodiments may also be provided in combination in a single embodiment. Conversely, various features of the disclosure that are described in the context of a single embodiment may also be provided separately or in any subcombination.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

Reference herein to two elements “facing” or “facing toward” each other indicates that a straight line can be drawn from one of the elements to the other of the elements without contacting an intervening solid structure.

The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure.

The headings and Abstract of the Disclosure provided herein are for convenience only and do not interpret the scope or meaning of the embodiments.

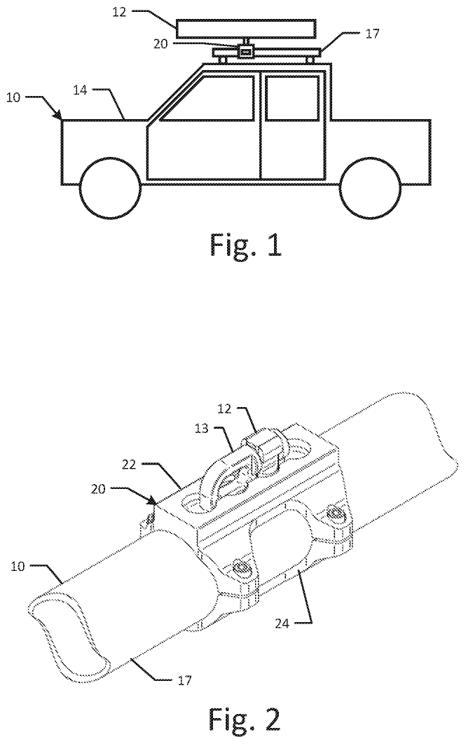

Referring to FIG. 1, a clamp assembly 20 can be mounted to a structure 10 to support an article 12. As shown in the illustrated embodiment, the structure 10 can be a motor vehicle 14, such as a car, truck, SUV, etc. (hereinafter “vehicle”). The structure 10 can also include stationary objects, such as a scaffolding or an office desk, for example. According to one aspect of the disclosure, the clamp assembly 20 can be mounted to a tubular structure 17 of the structure 10. The tubular structure 17 can be hollow with a circular cross-sectional shape as shown in the illustrated embodiment. According to another aspect of the disclosure, the tubular structure 17 can be solid. Additionally, the tubular structure 17 can define other, non-circular, cross-sectional shapes.

According to one embodiment, the tubular structure 17 can include a roll bar 18 of the vehicle 14. The roll bar 18 can be located in a passenger compartment of the vehicle 14, for example in an open-top vehicle. Additionally, the roll bar 18 can be located in a cargo area of the vehicle 14, for example in the bed of a pickup truck. The tubular structure 17 can be an integral structure with the vehicle 14, such that the tubular structure 17 is not removable from the vehicle without plastically deforming at least one of the tubular structure 17 and the vehicle 14. Additionally, the tubular structure 17 can be an add-on structure, for example a roof rack or roof rails that is removably attachable to the vehicle 14 without plastic deformation.

A plurality of the clamp assemblies 20 can be attached to the structure 10. The plurality of the clamp assemblies 20 can be arranged to cooperatively support the article 12. According to one embodiment, the plurality of the clamp assemblies 20 can be arranged to each support respective ones of the articles 12.

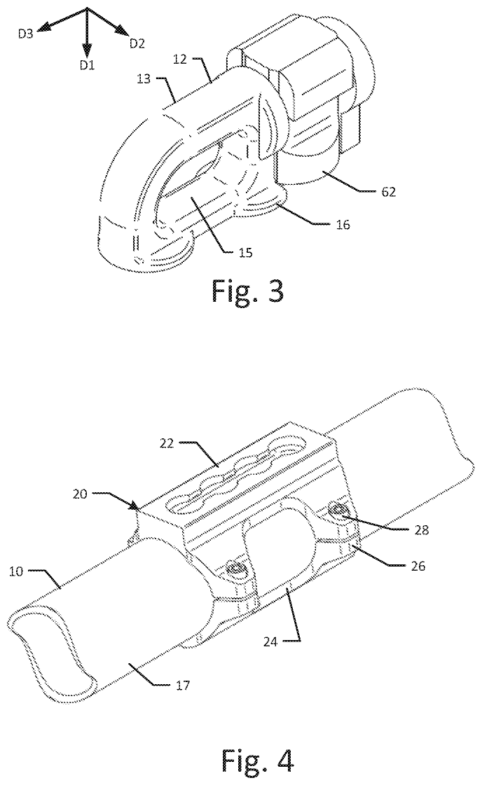

Referring to FIGS. 2 and 3, the article 12 can include a fitting 13, for example a cargo control fitting, such as a single (or as shown a double) stud seat track fitting. According to one embodiment, the fitting 13 can be integral with the article 12 being supported. Alternatively, the fitting 13 can be a separate piece that is adapted to couple a variety of different articles to the clamp assembly 20. Reference herein to the article 12 is applicable to the fitting 13, and reference herein to the fitting 13 is applicable to the article 12. Once the fitting 13 is secured to the clamp assembly 20, as will be explained in greater detail below, one or more articles 12 may be coupled to the fitting 13, for example through the use of a loop 15 defined by the fitting 13.

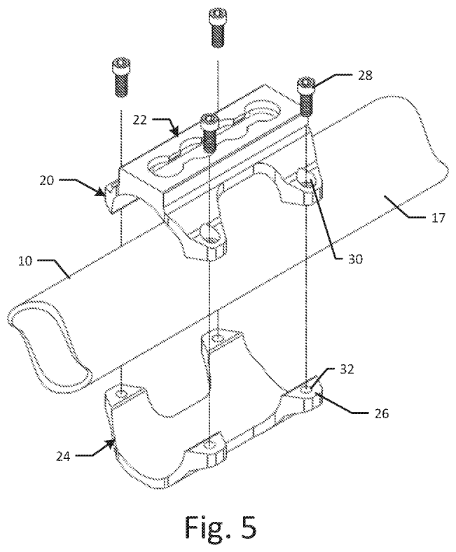

Referring to FIGS. 4 and 5, the clamp assembly 20 can include a first clamp portion 22 and a second clamp portion 24 securable to one another such that the structure 10, for example the tubular structure 17, is captured between the first clamp portion 22 and the second clamp portion 24. It will be appreciated by those of skill in the art that the clamp assembly 20 can include additional clamp portions such that the clamp assembly 20 includes more than two clamp portions.

The clamp assembly 20 can include an attachment mechanism 26 that facilitates transition of the clamp assembly 20 from a first configuration in which the first clamp portion 22 is movable relative to the second clamp portion 24 (also referred to herein as an “open configuration”), to a second configuration in which the first clamp portion 22 is fixed relative to the second clamp portion 24 (also referred to herein as a “closed configuration”).

As will be described in further detail below, when in the open configuration the clamp assembly 20 can be movable relative to the structure 10, for example such that the structure 10 is positioned between the first clamp portion 22 and the second clamp portion 24. As shown in the illustrated embodiment, when the clamp assembly 20 is transitioned to the closed configuration with the structure 10 positioned between the first clamp portion 22 and the second clamp portion 24, the clamp assembly 20 is secured to the structure 10.

According to one aspect of the disclosure, the attachment mechanism 26 can include at least one fastener 28, at least one first fastener receiving aperture 30 defined by the first clamp portion 22, and at least one second fastener receiving aperture 32 defined by the second clamp portion 24. It will be appreciated by those of skill in the art that the attachment mechanism 26 can include other structures used to selectively couple multiple components or portions, for example a hinge, tongue and groove, locking pin, etc.

According to one embodiment, the first fastener receiving aperture 30 can be a different size compared to the second fastener receiving aperture 32. For example, the first fastener receiving aperture 30 can be larger than the second fastener receiving aperture 32. The different relative sizes can allow the first clamp receiving aperture 30 to receive a head portion of the at least one fastener 28 and the second clamp receiving aperture to receive a shaft portion of the at least one fastener 28. The second clamp receiving aperture 32 can be threaded such that second clamp receiving aperture 32 corresponds to threads of the shaft portion of the at least one fastener 28.

Referring to FIGS. 4 to 7, the clamp assembly 20 can include a plurality of attachment mechanisms 26. As shown, the clamp assembly 20 can include a plurality of the first fastener receiving apertures 30. The plurality of the first fastener receiving apertures 30 can include a first adjacent pair of first fastener receiving apertures 30a spaced apart along the second direction D2. When in the open configuration a gap 33 can be defined by the first clamp portion 22 between the first adjacent pair of first fastener receiving apertures 30a with respect to the second direction D2.

The plurality of the first fastener receiving apertures 30 can include a second adjacent pair of first fastener receiving apertures 30b spaced apart along a third direction D3 such that a gap 35 is defined by the first clamp portion 22 between the second adjacent pair of first fastener receiving apertures 30b with respect to the third direction D3. According to one embodiment, the third direction D3, can be perpendicular to both the first direction D1 and the second direction D2. The first clamp portion 22 can be elongate along the third direction D3, according to one embodiment.

The clamp assembly 20 can include the first adjacent pair of first fastener receiving apertures 30a, the second adjacent pair of first fastener receiving apertures 30b, or both the first and the second adjacent pair of first fastener receiving apertures 30a, 30b. As shown, one of the first fastener receiving apertures 30 can be one of both the first adjacent pair of first fastener receiving apertures 30a and the second adjacent pair of first fastener receiving apertures 30b.

The first clamp portion 22 can include a first inner clamping surface 34 that faces, for example abuts, the structure 10. The first inner clamping surface 34 can define a cross-sectional shape that corresponds to, for example matches, an outer cross-sectional shape of the structure 10. As shown in the illustrated embodiment, the cross-sectional shape of the first inner clamping surface 34 can be circular, such that the first inner clamping surface 34 define a portion, for example no greater than 50%, of a circle. According to one embodiment, the cross-sectional shape can be defined within a plane that is normal to the third direction D3. The first inner clamping surface 34 can be positioned between the first adjacent pair of first fastener receiving apertures 30a with respect to the second direction D2, as shown.

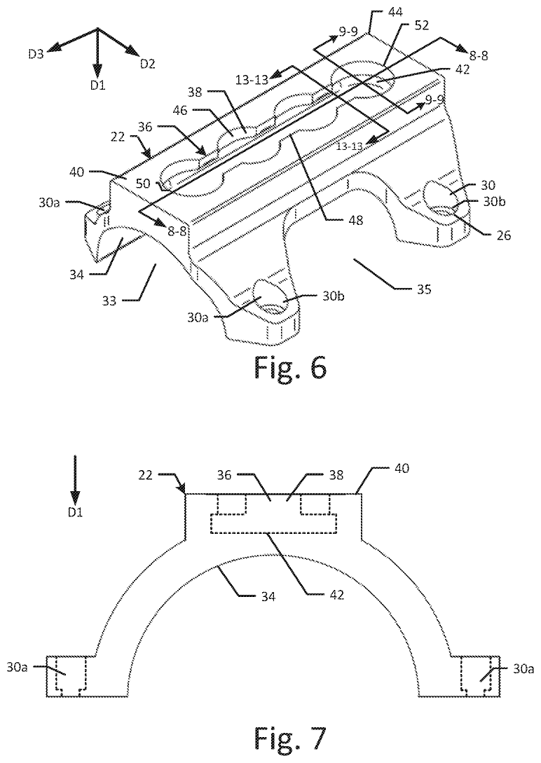

Referring to FIGS. 6 to 9, the first clamp portion 22 can further include a seat track 36, which facilitates attachment of the article 12 to the clamp assembly 20. As shown the seat track 36 can include a recess 38 defined by the first clamp portion 22, which extends through an outer surface 40 of the first clamp portion 22 in a first direction D1 and terminates at a base surface 42 of the first clamp portion 22. The base surface 42 can be positioned between the outer surface 40 and the first inner clamping surface 34 with respect to the first direction D1. Hidden lines, which define portions of the recess 38 and the first fastener receiving apertures 30 according to one embodiment of the disclosure are shown in dashed lines in FIG. 7.

The first clamp portion 22 can include at least one sidewall 43 that extends between the base surface 42 and the outer surface 40 thereby further defining the recess 38. The recess 38 can define a first width W1 measured at the outer surface 40 in a second direction D2, which can be perpendicular to the first direction D1 as shown in the illustrated embodiment. The recess 38 can further define a second width W2 at a location between the outer surface 40 and the base surface 42 with respect to the first direction D1. As shown in the illustrated embodiment, the second width W2 can be greater than the first width W1.

According to one embodiment, the outer surface 40 can be planar, such that the outer surface 40 is defined within a plane that is normal to the first direction D1. The outer surface 40 can define an outer perimeter 44 within the plane such that the recess 38 is entirely enclosed within the outer perimeter 44 such that the recess 38 and the outer perimeter 44 do not intersect.

The outer surface can define a first length L1 measured, for example, along the third direction D3. The recess 38 can define a second length L2 measured at the outer surface 40 in the third direction D3, and the recess 38 can further define a third length L3 at a location between the outer surface 40 and the base surface 42 with respect to the first direction D1. According to one embodiment, the location is adjacent the base surface 42. As shown in the illustrated embodiment, the first length L1 can be greater than the second length L2. Additionally, the third length L3 can be greater than the second length L2, and the third length L3 can be less than the first length L1.

The outer surface 40 can define a shape of the recess 38 within the plane that defines the outer surface 40 such that the shape includes a series of larger portions 46 and a series of smaller portions 48. As shown series of larger portions 46 and the series of smaller portions 48 can be alternatingly arranged. The larger portions 46 can define a first cross-sectional dimension measured within the plane and the smaller portions 48 can define a second cross-section dimension measured within the plane, and the first cross-sectional dimension can be greater than the second cross-sectional dimension.

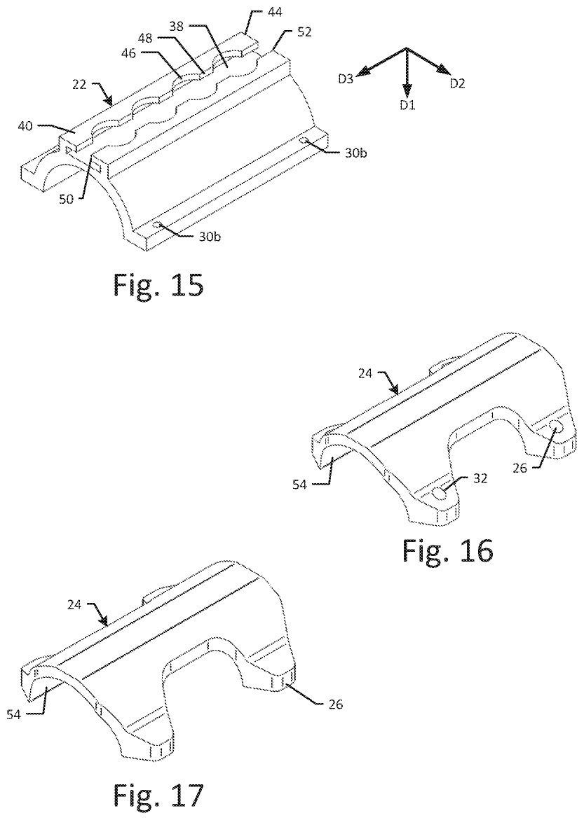

Referring to FIGS. 6 and 15, each of the series of larger portions 46 can define a circular shape within the outer surface 40. As shown, the recess 38 of the first clamp portion 22 can include a first terminal end 50 and a second terminal end 52. According to one embodiment, at least one, for example both, of the first terminal end 50 and the second terminal end 52 can be defined by respective ones of the series of larger portions 46. The outer surface 40 can define an outer perimeter 44 such that the recess 38 is entirely enclosed within the outer perimeter 44 such that the recess 38 and the outer perimeter 44 do not intersect as shown in FIG. 6.

According to another embodiment, at least one, for example both, of the first terminal end 50 and the second terminal end 52 can be open to the outer perimeter 44 such that the recess 38 is not entirely enclosed within the outer perimeter 44, for example such that the recess 38 and the outer perimeter 44 intersect as shown in FIG. 15. Also shown in FIG. 15 is an embodiment of the first clamp portion 22 devoid of the gap 35 between the second adjacent pair of first fastener receiving apertures 30b.

The series of smaller portions 48 can define a rectangular shape within the outer surface 40, as shown. The series of larger portions 46 and the series of smaller portions 48 can define other shapes, than those described above. For example, each of the series of larger portions 46 can define a non-circular shape, for example a rectangle, within the outer surface 40. The series of smaller portions 48 can define a non-rectangular shape, for example a circle, within the outer surface 40.

Referring to FIGS. 16 and 17, the second clamp portion 24 can be identical to the first clamp portion 22, such that an entirety of the description herein of the first clamp portion 22 is applicable to the second clamp portion 24. According to one embodiment, the second clamp portion 24 is similar to the first clamp portion 24, such that all of the portions of the description of the first clamp portion 24 herein are applicable to the second clamp portion 24 except for the differences discussed below.

According to one embodiment, the second clamp portion 24 can include a complimentary feature of the attachment mechanism 26 to the portion of the attachment mechanism 26 supported by the first clamp portion 22. The complimentary feature can include the second fastener receiving aperture 32, which can be in the form of a through hole, as shown in FIG. 16, or in the form of a blind hole as shown in FIG. 17. As shown in the illustrated embodiment, the second clamp portion 24 can be devoid of the seat track 36.

The second clamp portion 24 can include a second inner clamping surface 54 that faces, for example abuts, the structure 10. The second inner clamping surface 54 can define a cross-sectional shape that corresponds to, for example matches, the outer cross-sectional shape of the structure 10. As shown in the illustrated embodiment, the cross-sectional shape of the second inner clamping surface 54 can be circular, such that the first inner clamping surface 34 defines a portion, for example no greater than 50%, of a circle. According to one aspect of the disclosure, the first inner clamping surface 34 and the second inner clamping surface 54 cooperatively define a shape that corresponds to the structure 10.

Referring to FIGS. 1 to 17, a method of mounting the clamp assembly 20 to the structure 10 can include positioning the first clamp portion 22 of the clamp assembly 20 relative to the second clamp portion 24 of the clamp assembly 20 such that both the first inner clamping surface 34 of the first clamp portion 22 and the second inner clamping surface 54 of the second clamp portion 24 abut the structure 10.

The method can include positioning the first clamp portion 22 of the clamp assembly 20 relative to the second clamp portion 24 of the clamp assembly 20 such that first fastener receiving aperture 30 defined by the first clamp portion 22 is aligned with the second fastener receiving aperture 32 defined by the second clamp portion 24 along the first direction D1. The method can include positioning the first clamp portion 22 of the clamp assembly 20 relative to the second clamp portion 24 of the clamp assembly 20 such that the recess 38 defined by the first clamp portion 22 extends through the outer surface 40 of the first clamp portion 22 in the first direction D1 and terminates at the base surface 42 of the first clamp portion 22.

The method can further include inserting the fastener 28 through one of the first fastener receiving aperture 30 and the second fastener receiving aperture 32 and into the other of the first fastener receiving aperture 30 and the second fastener receiving aperture 32, thereby simultaneously fixing the relative positions of the first clamp portion 22 and the second clamp portion 24 and securing the clamp assembly 20 relative to the structure 10.

The method can include moving the fastener 28 in the first direction D1 while inserting the fastener 28 through one of the first fastener receiving aperture 30 and the second fastener receiving aperture 32 and into the other of the first fastener receiving aperture 30 and the second fastener receiving aperture 32.

The method can further include inserting a second fastener 28 through another one of the first fastener receiving apertures 30 defined by the first clamp portion 22 and another one of the second fastener receiving apertures 32 defined by the second clamp portion 24 and into the other of the another one of the second fastener receiving apertures 32 and the another one of the second fastener receiving apertures 32.

A method of securing the article 12 to the structure 10, for example the tubular structure 17, can include positioning the first clamp portion 22 of the clamp assembly 20 relative to the second clamp portion 24 of the clamp assembly 20 such that both the first inner clamping surface 34 and the second inner clamping surface 54 abut the tubular structure 17. The method of securing the article can include simultaneously fixing the relative positions of the first clamp portion 22 and the second clamp portion 24 and securing the clamp assembly 20 relative to the tubular structure 17.

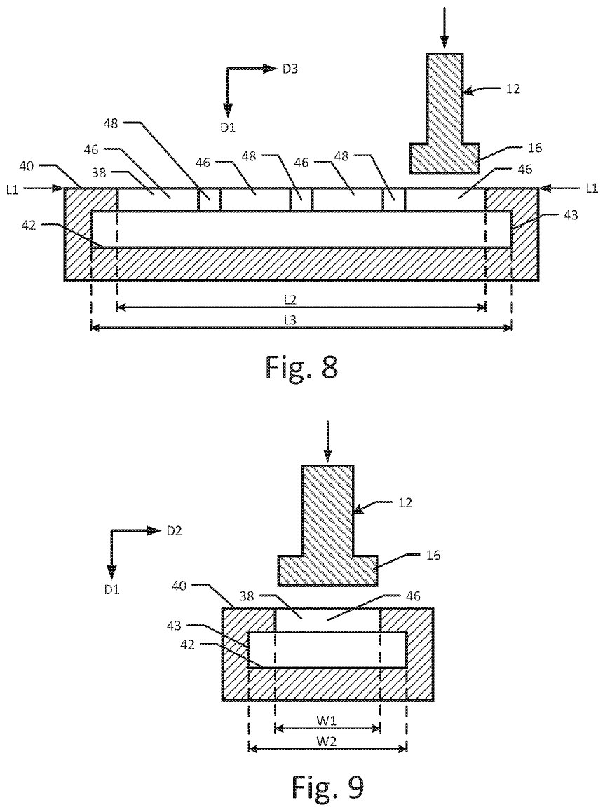

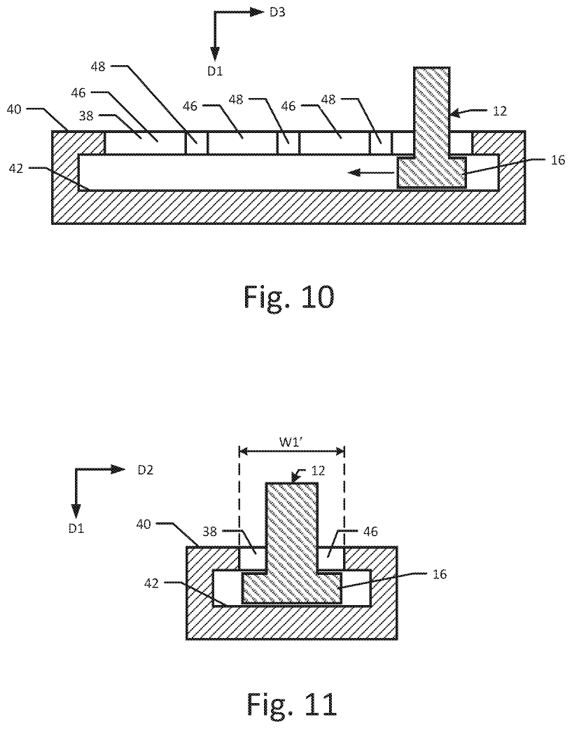

As shown in FIGS. 8 and 9, the method of securing the article 12 can include inserting a portion 16 of the article 12 through a first portion, for example one of the series of larger portions 46 of the recess 38 defined by the first clamp portion 22 by advancing the article 12 in the first direction D1. The article 12 can be advanced in the first direction D1 until the portion 16 of the article 12 is positioned within the recess 38, for example such that the portion 16 of the article 12 abuts the base surface 42, as shown in FIGS. 10 and 11. As shown in FIG. 3, the portion 16 of the fitting 13 can include a flange, or a pair of flanges. The fitting 13 can include a single flange or pair of flanges, or multiple flanges or pairs of flanges as shown in the illustrated embodiment.

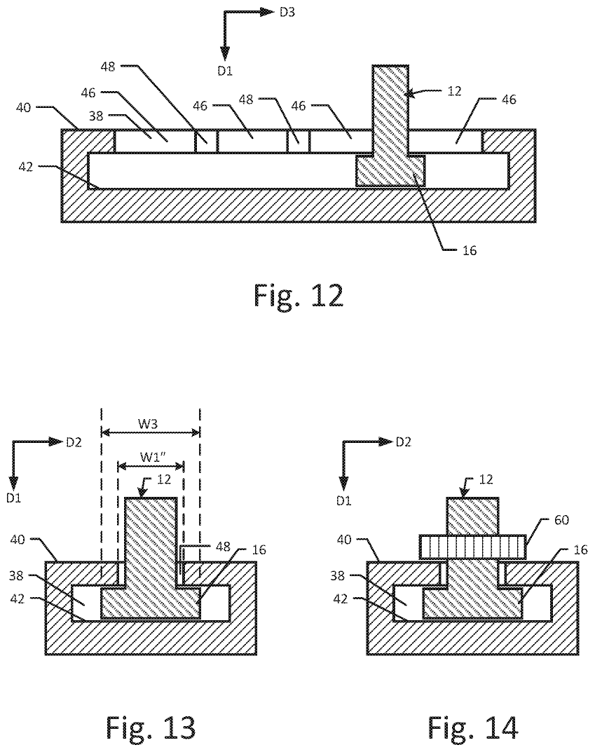

As shown in FIGS. 12 to 14, the method of securing the article 12 can include aligning the portion 16 of the article 12 with a second portion, for example one of the series of smaller portions 48 of the recess 38 that the portion 16 of the article 12 does not fit through the second portion with respect to the first direction D1 (or a direction opposite the first direction D1), thereby trapping the portion 16 of the article 12 within the recess 38. A fastener 60 can be used to secure the article 12 within the recess 38. According to one example, the fastener 60 can be a threaded nut that rides corresponding threads on the article 12.

The method of securing the article 12 can include advancing the article 12 in the second direction D2, as shown by the arrow in FIG. 10. The first width W1 defined by the recess 38 can include a first value W1′ when measured, for example in the second direction D2, at one of the larger portions 46, and a second value W1″ when measured, for example in the second direction D2, at one of the smaller portions 48. As shown the first value W1′ can be greater than the second value W1″.

As shown, the portion 16 of the article 12 can define a width W3 measured in the second direction D2 that is less than the first value W1′ and greater than the second value W1″.

Referring to FIGS. 2 and 3, the fitting 13 can include a biased member 62. Securing the article 12 can include providing a biasing force to the biased member 62 while inserting the portion 16 of the article 12 through the first portion. The method of securing the article 12 can further include releasing the biasing force from the biased member 62 while advancing the article 12 in the second direction D2. Releasing the biasing force can allow the biased member 62 to “snap” down into the recess 38 in the first direction D1, such that the biasing member 62 blocks additional movement of the article 12 relative to the clamp assembly 20 along at least one of the second direction D2 and the third direction D3.

Referring to FIGS. 1 to 17, a kit can be provided that includes a plurality of the clamp assemblies 20 as described herein. For example the kit can include a plurality of the first clamp portion 22 and a plurality of the second clamp portion 24. The plurality of clamp assemblies 20 can be of different sizes. For example a first of the plurality of clamp assemblies 20 can define a first length and a second of the plurality of clamp assemblies 20 can define a second length different from the first length. According to one example a first of the plurality of clamp assemblies 20 can include first and second inner clamping surfaces 34, 54 that cooperatively define a first shape, such as a circle, and a second of the plurality of clamp assemblies 20 can include first and second inner clamping surfaces 34, 54 that cooperatively define a second shape, such as a non-circular shape, for example a rectangular shape.

This application claims priority to U.S. patent application 62/892,278, filed Aug. 27, 2019, the disclosure of which is hereby incorporated by reference, in its entirety.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

Many of the methods described herein can be performed with variations. For example, many of the methods may include additional acts, omit some acts, and/or perform acts in a different order than as illustrated or described. The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A clamp assembly to be mounted to a structure, the clamp assembly comprising:
a first clamp portion including a first inner clamping surface and an outer surface, the first clamp portion defining a recess, which extends through the outer surface in a first direction and terminates at a base surface of the first clamp portion, the base surface positioned between the outer surface and the first inner clamping surface with respect to the first direction, wherein the recess defines a first width within a plane defined by the first direction and a second direction that is perpendicular to the first direction, the first width measured at the outer surface and in the second direction, the recess defines a second width within the plane at a location between the outer surface and the base surface, the second width measured in the second direction, and the second width being greater than the first width; and
a second clamp portion including a second inner clamping surface,
wherein the first clamp portion is securable to the second clamp portion such that the structure is captured between the first inner clamping surface and the second inner clamping surface.

2. The clamp assembly of claim 1, further comprising: an attachment mechanism that transitions from a first configuration in which the first clamp portion is movable relative to the second clamp portion, to a second configuration in which the first clamp portion is fixed relative to the second clamp portion.

3. The clamp assembly of claim 2 wherein the attachment mechanism includes at least one fastener, at least one first fastener receiving aperture defined by one of the first clamp portion and the second clamp portion, and at least one second fastener receiving aperture defined by the other of the first clamp portion and the second clamp portion.

4. The clamp assembly of claim 3 wherein the at least one first clamp receiving aperture is larger than the at least one second clamp receiving aperture such that the first clamp receiving aperture is sized to receive a head portion of the at least one fastener, the at least one second clamp receiving aperture is smaller than the head portion, and the at least one second clamp receiving aperture is smaller than the first clamp receiving aperture and sized to receive a shaft portion of the at least one fastener.

5. The clamp assembly of claim 4 wherein the at least one second clamp receiving aperture is threaded such that the at least one second clamp receiving aperture corresponds to threads of the shaft portion of the at least one fastener.

6. The clamp assembly of claim 3 wherein the at least one first fastener receiving aperture includes:
a first adjacent pair of first fastener receiving apertures spaced apart along the second direction such that the first inner clamping surface is between the first adjacent pair of first fastener receiving apertures; and
a second adjacent pair of first fastener receiving apertures spaced apart along a third direction that is perpendicular to both the first direction and the second direction, such that a gap is defined by the first clamp portion between the second adjacent pair of first fastener receiving apertures with respect to the third direction.

7. The clamp assembly of claim 6 wherein the first clamp portion is elongate along the third direction.

8. The clamp assembly of claim 6 wherein one of the at least one first fastener receiving apertures is one of both the first adjacent pair of first fastener receiving apertures and the second adjacent pair of first fastener receiving apertures.

9. The clamp assembly of claim 1 wherein the first inner clamping surface and the second inner clamping surface cooperatively define a cross-sectional shape defined within the plane that corresponds to the structure.

10. The clamp assembly of claim 9 wherein the shape and the structure are circular within a plane.

11. The clamp assembly of claim 1 wherein the outer surface is defined within a plane that is normal to the first direction, the outer surface defines an outer perimeter within the plane, and the first terminal end, the second terminal end, or both the first terminal end and the second terminal end is open to the outer perimeter such that the recess and the outer perimeter intersect.

12. The clamp assembly of claim 1 wherein the outer surface is defined within a plane that is normal to the first direction, the outer surface defines an outer perimeter within the plane, and the recess is entirely enclosed within the outer perimeter with respect to the plane such that the recess and the outer perimeter do not intersect.

13. The clamp assembly of claim 12 wherein the outer surface defines a shape of the recess within the plane, and the shape of the recess includes a series of larger portions and a series of smaller portions alternatingly arranged, the larger portions defining a first cross-sectional dimension measured within the plane, the smaller portions defining a second cross-section dimension measured within the plane, and the first cross-sectional dimension is greater than the second cross-sectional dimension.

14. The clamp assembly of claim 13 wherein each of the series of larger portions defines a circular shape within the plane.

15. The clamp assembly of claim 13 wherein the recess includes a first terminal end and a second terminal end, and both the first terminal end and the second terminal end are defined by respective ones of the series of larger portions.

16. The clamp assembly of claim 13 wherein each of the series of smaller portions defines a rectangular shape within the plane.

17. The clamp assembly of claim 1 wherein the location is adjacent the base surface.

18. The clamp assembly of claim 1 wherein the first clamp portion includes at least one sidewall that extends between the base surface and the outer surface thereby further defining the recess.

19. The clamp assembly of claim 1 wherein the second clamp portion defines a second recess, which extends through a second outer surface of the second clamp portion and terminates at a second base surface of the second clamp portion, the second base surface positioned between the second outer surface and the second inner clamping surface, wherein the second recess defines a third width at the second outer surface and a fourth width at a second location between the second outer surface and the second base surface, and the fourth width being greater than the third width.

20. The clamp assembly of claim 19 wherein the second recess extends through the second outer surface of the second clamp portion in a direction opposite the first direction, and both the third width and the fourth width are measured in the second direction.

21. A method of mounting a clamp assembly to a structure, the method comprising:
positioning a first clamp portion of the clamp assembly relative to a second clamp portion of the clamp assembly such that:
both a first inner clamping surface of the first clamp portion and a second inner clamping surface of the second clamp portion abut the structure;
a first fastener receiving aperture defined by the first clamp portion is aligned with a second fastener receiving aperture defined by the second clamp portion along a first direction; and
a recess defined by the first clamp portion extends through an outer surface of the first clamp portion in the first direction and terminates at a base surface of the first clamp portion, the base surface positioned between the outer surface and the first inner clamping surface with respect to the first direction, wherein the recess defines a first width at the outer surface and a second width at a location between the outer surface and the base surface, both the first width and the second width being measured in a second direction that is perpendicular to the first direction, and the second width being greater than the first width; and
inserting a fastener through one of the first fastener receiving aperture and the second fastener receiving aperture and into the other of the first fastener receiving aperture and the second fastener receiving aperture, thereby simultaneously fixing the relative positions of the first clamp portion and the second clamp portion and securing the clamp assembly relative to the structure.

22. The method of claim 21, further comprising:
moving the fastener in the first direction while inserting the fastener through one of the first fastener receiving aperture and the second fastener receiving aperture and into the other of the first fastener receiving aperture and the second fastener receiving aperture.

23. The method of claim 21 wherein the fastener is a first fastener, the method further comprising:
inserting a second fastener through one of a third fastener receiving aperture defined by the first clamp portion and a fourth fastener receiving aperture defined by the second clamp portion and into the other of the third fastener receiving aperture and the fourth fastener receiving aperture,
wherein the first clamp portion defines a gap between the first fastener receiving aperture and the third fastener receiving aperture with respect to a third direction that is perpendicular to both the first direction and the second direction.

24. A method of securing an article to a tubular structure, the method comprising:
positioning a first clamp portion of the clamp assembly relative to a second clamp portion of the clamp assembly such that both a first inner clamping surface of the first clamp portion and a second inner clamping surface of the second clamp portion abut the tubular structure;
simultaneously fixing the relative positions of the first clamp portion and the second clamp portion and securing the clamp assembly relative to the tubular structure;
inserting a portion of the article through a first portion of a recess defined by the first clamp portion by advancing the article in a first direction, wherein the recess extends through an outer surface of the first clamp portion in the first direction and terminates at a base surface of the first clamp portion, the base surface positioned between the outer surface and the first inner clamping surface with respect to the first direction; and
aligning the portion of the article with a second portion of the recess that the portion of the article does not fit through with respect to the first direction, thereby trapping the portion of the article within the recess.

25. The method of claim 24 wherein aligning the portion of the article includes advancing the article in a second direction that is perpendicular to the first direction.

26. The method of claim 25 wherein the first portion of the recess defines a first width measured in a third direction that is perpendicular to both the first direction and the second direction, the portion of the article defines a second width measured in the third direction, the second portion of the recess defines a third width measured in the third direction, the first width is greater than the second width, and the second width is greater than the third width.
